(19) United States
(12) Patent Application Publication
(10) Pub. No.: US 2026/0162327 A1
(43) Pub. Date: Jun. 11, 2026

(54) GENERATING IMAGES FOR VIDEO COMMUNICATION SESSIONS

(71) Applicant: Google LLC, Mountain View, CA (US)

(72) Inventors: Ryan FEDYK, Mountain View, CA (US); Anton VOLKOV, Mountain View, CA (US)

(73) Assignee: Google LLC, Mountain View, CA (US)

(21) Appl. No.: 19/135,048

(22) PCT Filed: Aug. 21, 2023
(86) PCT No.: PCT/US2023/030730

§ 371 Date: Jun. 2, 2025

(51) Int. Cl. G06T 11/60; G06F 40/166; G06F 40/279; G06F 40/40

(52) U.S. Cl. CPC G06T 11/60; G06F 40/166; G06F 40/279; G06F 40/40; G06T 2200/24

(57) ABSTRACT

A media application obtains transcribed text from audio associated with a video communication session. The media application provides, to a text-generation machine-learning model, the transcribed text. The text-generation machine-learning model outputs a text prompt based on the transcribed text, where the text prompt includes an entity in the transcribed text.

The media application provides the text prompt to an image-generation machine-learning model. The image-generation machine-learning model outputs a generated image that is responsive to the text prompt, where the generated image includes a depiction of the entity in the transcribed text. The media application causes the generated image to be displayed in the video communication session.

### BACKGROUND

Generating images for a video conference that occurs in real-time is difficult because the topics can be diverse and can change quickly. A user may retrieve an image from a database and add the image to the video conference, but the time it takes to identify and retrieve an image may render the image irrelevant by the time the user locates and shares the image.

In addition, when a user saves recordings of video communication sessions, it may be difficult for the user to remember the subject matter discussed in a video communication session. This problem may be exacerbated by each additional video communication that the user saves.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

A computer-implemented method includes obtaining transcribed text from audio associated with a video communication session. The method further includes providing, to a text-generation machine-learning model, the transcribed text. The method further includes outputting, with the text-generation machine-learning model, a text prompt based on the transcribed text, where the text prompt includes an entity in the transcribed text. The method further includes providing the text prompt to an image-generation machine-learning model. The method further includes outputting, with the image-generation machine-learning model, a generated image that is responsive to the text prompt, where the generated image includes a depiction of the entity in the transcribed text. The method further includes causing the generated image to be displayed in the video communication session.

In some embodiments, the method further includes identifying the entity from the transcribed text by: generating a summary of the transcribed text and comparing the summary to a plurality of clusters of entities to identify the entity based on corresponding distances between the summary and the plurality of clusters of entities, where the summary is provided to the text-generation machine-learning model. In some embodiments, the generated image is displayed as a background image behind a video of one or more participants in the video communication session.

In some embodiments, the method further includes obtaining additional transcribed text from audio associated with the video communication session; outputting, with the text-generation machine-learning model, a further text prompt based on the additional transcribed text, where the further text prompt includes an additional entity in the additional transcribed text; providing the further text prompt to the image-generation machine-learning model; and updating, with the image-generation machine-learning model, the generated image to be responsive to the further text prompt, where the updated generated image includes a depiction of the additional entity in the additional transcribed text. In some embodiments, the video communication session is a live session, and the method is performed a plurality of times during the live session with incremental audio received during a period between consecutive execution of the method.

In some embodiments, the entity includes a plurality of entities and the plurality of entities transition into other entities based on the incremental audio. In some embodiments, the method further includes generating a summary of the transcribed text and indexing the summary of the transcribed text with a thumbnail version of the generated image. In some embodiments, the method further includes scoring, with the text-generation machine-learning model, a set of entities based on a visual aspect associated with each entity in the set of entities, where outputting the text prompt comprises outputting the text prompt with the entity associated with a highest score. In some embodiments, the entity is a plurality of entities, a first entity is based on audio from a first user associated with the video communication session, a second entity is based on audio from a second user associated with the video communication session, and the generated image depicts a logical connection between the first entity and the second entity.

In some embodiments, the method further includes prior to the video communication session, receiving prewritten text; outputting, with the image-generation machine-learning model, one or more images based on entities detected in the prewritten text; detecting that the transcribed text matches a particular portion of the prewritten text; and causing a corresponding pre-generated image to be displayed in the video communication session. In some embodiments, the method further includes generating graphical data for displaying a user interface that includes a set of suggested backgrounds for use during the video communication session, where the set of suggested backgrounds include the one or more images. In some embodiments, the method further includes providing an option to save the generated image in association with the transcribed text of the video communication session. In some embodiments, the method further includes deleting the transcribed text after the video communication session ends.

In some embodiments, a non-transitory computer-readable medium with instructions stored thereon that, when executed by one or more processors, cause the one or more processors to perform operations including: obtaining transcribed text from audio associated with a video communication session; providing, to a text-generation machine-learning model, the transcribed text; outputting, with the text-generation machine-learning model, a text prompt based on the transcribed text, wherein the text prompt includes an entity in the transcribed text; providing the text prompt to an image-generation machine-learning model; generating, with the image-generation machine-learning model, a generated image that is responsive to the text prompt, wherein the generated image includes a depiction of the entity in the transcribed text; and causing the generated image to be displayed in the video communication session.

In some embodiments, the operations further include identifying the entity from the transcribed text by: generating a summary of the transcribed text; and comparing the summary to a plurality of clusters of entities to identify the entity based on corresponding distances between the summary and the plurality of clusters of entities, where the summary is provided to the text-generation machine-learning model. In some embodiments, the generated image is displayed as a background image behind a video of one or more participants in the video communication session. In some embodiments, the operations further include obtaining additional transcribed text from audio associated with the video communication session; outputting, with the text-generation machine-learning model, a further text prompt based on the additional transcribed text, wherein the further text prompt includes an additional entity in the additional transcribed text; providing the further text prompt to the image-generation machine-learning model; and updating, with the image-generation machine-learning model, the generated image to be responsive to the further text prompt, wherein the updated generated image includes a depiction of the additional entity in the additional transcribed text.

In some embodiments, a computing device comprises one or more processors and a memory coupled to the one or more processors, with instructions stored thereon that, when executed by the processor, cause the processor to perform operations. The operations may include obtaining transcribed text from audio associated with a video communication session; providing, to a text-generation machine-learning model, the transcribed text; outputting, with the text-generation machine-learning model, a text prompt based on the transcribed text, wherein the text prompt includes an entity in the transcribed text; providing the text prompt to an image-generation machine-learning model; generating, with the image-generation machine-learning model, a generated image that is responsive to the text prompt, wherein the generated image includes a depiction of the entity in the transcribed text; and causing the generated image to be displayed in the video communication session.

In some embodiments, the operations further include identifying the entity from the transcribed text by: generating a summary of the transcribed text; and comparing the summary to a plurality of clusters of entities to identify the entity based on corresponding distances between the summary and the plurality of clusters of entities, where the summary is provided to the text-generation machine-learning model. In some embodiments, the generated image is displayed as a background image behind a video of one or more participants in the video communication session.

### BRIEF DESCRIPTION OF THE DRAWINGS

FIG. 1 is a block diagram of an example network environment to generate images for video communication sessions, according to some embodiments described herein.

FIG. 2 is a block diagram of an example computing device to generate images for video communication sessions, according to some embodiments described herein.

FIG. 3 illustrates an example user interface that includes a generated image, according to some embodiments described herein.

FIG. 4 illustrate an example user interface that includes a background generated image, according to some embodiments described herein.

FIG. 5 illustrates an example user interface with suggested backgrounds that are pre-generated for use during a video communication session, according to some embodiments described herein.

FIG. 6 illustrates an example user interface with thumbnail versions of generated images that are indexed according to the video communication sessions, according to some embodiments described herein.

FIG. 7 illustrates an example flowchart of a method to output a generated image for a video communication session, according to some embodiments described herein.

FIG. 8 illustrates another example flowchart of a method to output a generated image for a video communication session, according to some embodiments described herein.

### DETAILED DESCRIPTION

Generating images for a video conference that occurs in real-time is difficult because the topics of video conferences can be diverse and can change quickly. The methods, systems, and non-transitory computer-readable media described herein generate images during a live video communication session, where the images are representative of topics and conversation in the video communication session are updated along with the audio in the session, and provide relevant visual content automatically. The described techniques use both a text-generation machine-learning model and an image-generation machine-learning model to automatically generate relevant images, e.g., that depict one or more entities discussed in audio and/or text exchanged between participants of a video communication session. The described techniques provide technical benefits by reducing the computational cost incurred when one or more participants in a video communication session perform image searches, preview multiple images, and select particular images for inclusion in the video communication session. The techniques are also advantageous because image content relevant to a live topic of discussion are generated and displayed in substantially real-time, which is not feasible with current manual identification of images.

In some embodiments, the techniques may be implemented to generate images in advance of a video communication session (e.g., for storytelling, presentations, etc. with some aspects of the content for the video communication session being known in advance) and the generated images are surfaced automatically in the video communication session based on matching live audio and/or text of the session with the previously generated images (and/or associated text). In this manner, the described techniques also save computational cost incurred during a video communication session by precaching relevant images, such that little or no computational resources are utilized for participants to perform searches, image previews, or image selection during a video communication session.

In some embodiments, a text-generation machine-learning model transcribes text from a video communication session and outputs a text prompt that includes an entity that is included in the transcribed text. For example, a first user may discuss her activities in Central Park last weekend and a second user may discuss that he recently saw an animated movie. The text-generation machine-learning model may output a text prompt that includes Central Park and the name of the animated movie.

In some embodiments, an image-generation machine-learning model receives the text prompt and outputs a generated image that includes a depiction of one or more entities in the transcribed text. For example, the image-generation machine-learning model may output a generated image that includes a depiction of Central Park as if it were in the animated movie. An initial image of Central Park may be generated based on the first user's audio and may be updated to modify the depiction of Central Park to a visual style that matches the visual style of the animated movie. The generated image may also be used as a thumbnail image that is used to index a summary of the transcribed text for future retrieval. This may improve the ability to query a data store on which transcribed text (or other associated content, such as audio/video recordings) are stored, improving efficiency by allowing a query process to operate over visual elements rather than dense text transcriptions, for example. A user may readily recognize visual elements more quickly than text and/or a search query process may be targeted to provide results according to the characteristics of the thumbnail image.

### Example Environment 100

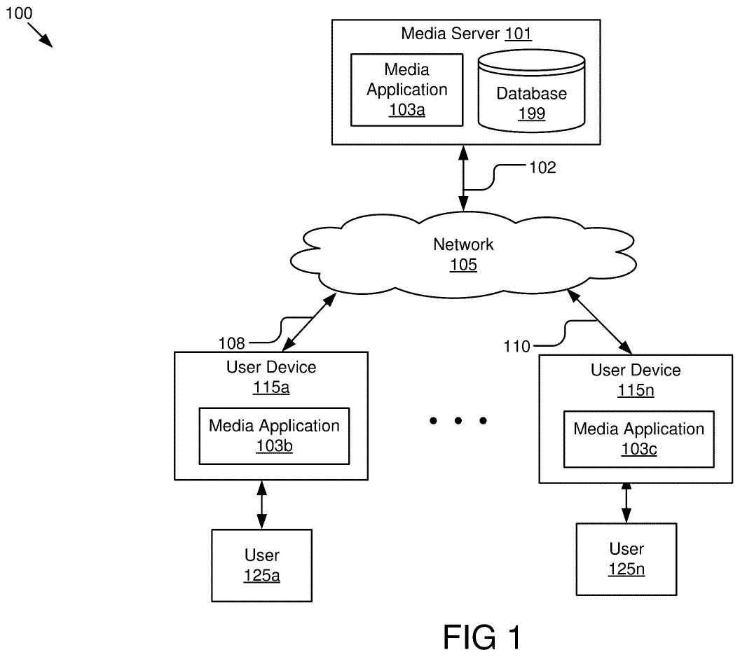

FIG. 1 illustrates a block diagram of an example environment 100 to generate images for video communication sessions. In some embodiments, the environment 100 includes a media server 101, a user device 115a, and a user device 115n that are coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, video communication sessions (with user permission), generated images (with user permission), etc.

The database 199 may also store social network data associated with users 125, user preferences for the users 125, etc.

The user device 115 may be a computing device that includes a memory coupled to a hardware processor. For example, the user device 115 may include a mobile device, a tablet computer, a laptop computer, a desktop computer, a mobile telephone, a wearable device, a head-mounted display, a mobile email device, a portable game player, a portable music player, a reader device, or another electronic device capable of accessing a network 105.

In the illustrated implementation, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

In some embodiments, the operations described herein are performed on the media server 101 and/or the user device 115. In some embodiments, some operations may be performed on the media server 101 and some may be performed on the user device 115.

Performance of operations is in accordance with user settings. For example, the user 125a may specify settings that operations are to be performed on their respective user device 115a and not on the media server 101. With such settings, operations described herein are performed entirely on user device 115a and no operations are performed on the media server 101. Further, a user 125a may specify that video and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time, e.g., such that they can enable or disable the use of the media server 101.

Machine learning models (e.g., neural networks or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. Updated model parameters may be transmitted to the media server 101 if permitted by the user 125, e.g., to enable federated learning. Model parameters do not include any user data.

In some embodiments, the media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

The media application 103 obtains transcribed text from audio associated with a video communication session. In some embodiments, the media application 103 includes a text-generation machine-learning model that receives the transcribed text and outputs a text prompt based on the transcribed text. The text prompt includes an entity in the transcribed text, such as a location, a person, a video game, etc.

The media application 103 includes an image-generation machine-learning model that receives the text prompt. The image-generation machine-learning model generates a generated image that is responsive to the text prompt. The generated image includes a depiction of the entity in the transcribed text.

### Example Computing Device 200

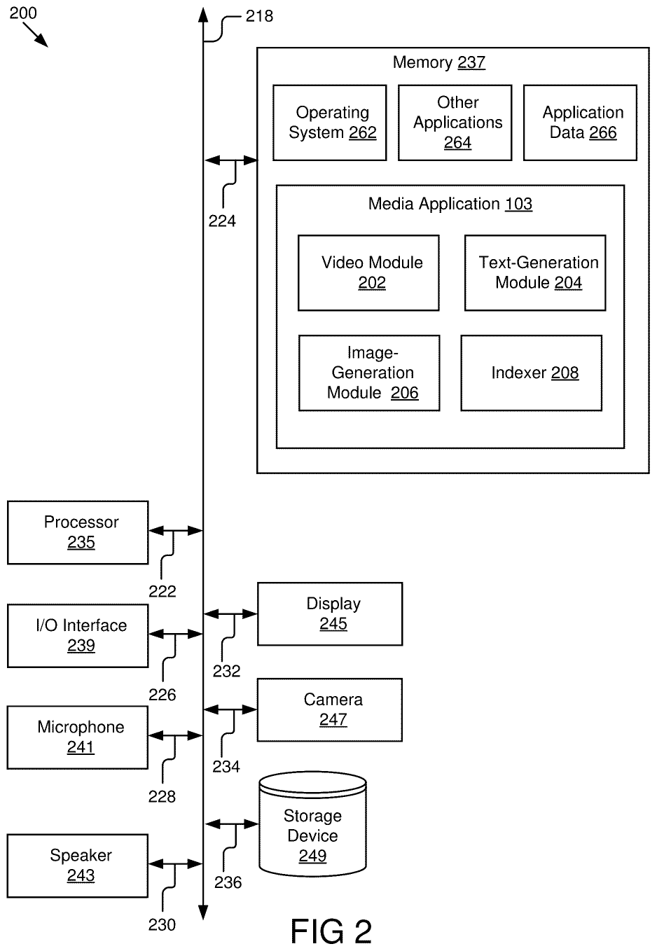

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a microphone 241, a speaker 243, a display 245, a camera 247, and a storage device 249, all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the display 245 may be coupled to the bus 218 via signal line 232, the camera 247 may be coupled to the bus 218 via signal line 234, and the storage device 249 may be coupled to the bus 218 via signal line 236.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., a video library application, a video management application, a video gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include videos used by the video library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 249), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

The microphone 241 may include hardware for detecting sounds. For example, the microphone 241 may detect ambient noises, people speaking, music, etc. using a single microphone 241 that is part of the user device 115.

In some embodiments, the microphone 241 includes additional hardware for processing audio that is captured while a user is recording a video. An analog to digital converter may convert analog electrical signals to digital electrical signals. A digital signal processor may convert the digital electrical signals into a digital output signal that is transmitted to the speaker 243.

The speaker 243 may include hardware for producing an audio signal that is heard by the user. In some embodiments, the speaker 243 includes an amplifier that is used to amplify certain channels, frequencies, etc.

A display 245 includes hardware to display content, e.g., images, video, and/or a user interface of an output application as described herein, and to receive touch (or gesture) input from a user. For example, display 245 may be utilized to display a user interface that includes a set of suggested backgrounds for use during a video communication session. Display 245 can include any suitable display device such as a liquid crystal display (LCD), light emitting diode (LED), or plasma display screen, cathode ray tube (CRT), television, monitor, touchscreen, three-dimensional display screen, or other visual display device. For example, display 245 can be a flat display screen provided on a mobile device, multiple display screens embedded in a glasses form factor or headset device, or a monitor screen for a computer device.

Camera 247 may be any type of image capture device that can capture images and/or video. In some embodiments, the camera 247 captures images or video that the I/O interface 239 transmits to the media application 103.

The storage device 249 stores data related to the media application 103. For example, the storage device 249 may store a training data set, a text-generation machine-learning model, an image-generation machine-learning model, videos (with user permission), summaries (with user permission), etc.

FIG. 2 illustrates an example media application 103 that includes a video module 202, a text-generation module 204, an image-generation module 206, and an indexer 208. In some embodiments, each of the modules includes a set of instructions executable by the processor 235 to perform the steps discussed in greater detail below. In some embodiments, each of the components are stored in the memory 237 of the computing device 200 and can be accessible and executable by the processor 235.

Various embodiments described herein may include programmatic analysis of audio, video, text, or other media that are part of a video communication session. For example, audio may include spoken audio from participants (or other audio such as recorded audio, audio detected by the participant's microphone, etc.) in a video communication session, video may include a video that features the participant (e.g., from a camera) or other video content (e.g., a shared screen, a streamed video, etc.), text may include chat messages exchanged between the participants, other media may include files (e.g., documents, images, multimedia objects, etc.) etc. Programmatic analysis of the audio, video, text, or other media (content) is performed with specific user permission from participants of the video communication session, e.g., the participant that provides the particular content, participants that receive the particular content, all participants in the video communication session, a moderator or host of the video communication session, etc. Participants are provided notice that such programmatic analysis may be performed and can choose to selectively enable or disable programmatic analysis. No programmatic analysis is performed if a participant declines permission. Further, the content that is analyzed is processed in accordance with applicable laws and regulations, is processed in a secure manner (e.g., locally on a user device, or centrally on a server, using encryption and/or other security techniques). No content is stored without user permission. Further, the techniques are disabled entirely for certain sets of users, e.g., users that do not meet an age criteria, users associated with particular organizations where organizational policy prevents programmatic analysis, etc.

The video module 202 facilitates a video communication session. For example, the video module 202 may be stored on a server, and include instructions to receive a first video stream from a first user device, and transmit the first video stream to a second user device. The video streams include audio. In some embodiments, the video module 202 transcribes the audio to transcribed text. For example, the video module 202 may include a transcription machine-learning model or other speech-to-text engine.

The video module 202 obtains the transcribed text from audio associated with a video communication session. The video module 202 may transmit the transcribed text to the text-generation module 204.

In some embodiments, the video module 202 obtains additional transcribed text from audio associated with the video communication session. For example, the video communication session may be a live session and the video module 202 may generate transcribed text with incremental audio as additional audio is received during the video communication session. In some embodiments, the video module 202 generates the transcribed text iteratively, such as after each person speaks a word or sentence, every minute, every five minutes, etc. The video module 202 may transmit the additional transcribed text to the text-generation module 204 as the transcribed text is generated.

In some embodiments the text-generation module 204 generates a summary from the transcribed text. The summary may include a list of participants, entities that are discussed in the transcribed text (e.g., Sarah went to the natural-history museum next to Central Park on Sunday), emotions associated with the entities (e.g., Sarah had the best time), etc. In this example, the entities may include “Sarah,” “natural-history museum”, “Central Park,” and “Sunday” and emotions include “enjoyment,” “happiness,” etc. (associated with the text “had the best time”).

In some embodiments, the text-generation module 204 includes a text-generation machine-learning model that receives the transcribed text as input and outputs the summary. The text-generation machine-learning model may be a large language model (LLM). In some embodiments, the text-generation module 204 compares the summary to a plurality of clusters of entities to identify one or more entities in the summary based on corresponding distances between the summary and the plurality of clusters of entities. In some embodiments, the text-generation module 204 uses a knowledge graph that includes information about entities to supplement the summary. The knowledge graph may be part of the media application 103 or part of a third-party service. The summary may be provided to the text-generation machine-learning model instead of the transcribed text.

In some embodiments, the text-generation module 204 uses a text-generation machine-learning model to output a text prompt based on the transcribed text or, if the text-generation module 204 also includes a summary, based on the summary. The text prompt includes one or more entities from the transcribed text. Continuing with the example above, the text-generation machine-learning model may receive the summary and/or transcribed text describing that Sarah went to a museum on Sunday and had the best time. The text-generation machine-learning model may output a text prompt requesting an image of an older museum building made of bricks that is next to an overgrown garden where the ivy encroaches on the bricks of the museum. The text prompt may request an older museum building based on “natural-history museum.” Conversely, if the museum were a modern-art museum, the text prompt may include “in the style of art of the 20^{th} or 21^{st} century.”

In some embodiments, the text-generation machine-learning model is trained by the text-generation module 204 and may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive transcribed text as input data or application data 266. Such data can include, for example, one or more words or phrases per node, e.g., when the trained model is used for analysis, e.g., of text. Subsequent intermediate layers may receive as input, output of nodes of a previous layer per the connectivity specified in the model form or structure. These layers may also be referred to as hidden layers. A final layer (e.g., output layer) produces an output of the machine-learning model, such as a text prompt. In some embodiments, model form or structure also specifies a number and/or type of nodes in each layer.

In some embodiments, the text-generation machine-learning model identifies a set of entities in the transcribed text and outputs a score associated with each entity. In some embodiments, the text-generation machine-learning model outputs a higher score for more visual entities as compared to less-visual entities. For example, a higher score may be associated with the entity “sunflower” in “I saw sunflowers” compared to a score associated with the entity “music” in “I heard nice music.” If both types of entities occur close to each other, e.g., “I heard nice music in the café” the entity “café” may be associated with a higher score than the entity “music.” In some embodiments, more recent entities discussed in the transcribed text are given a higher priority than older entities discussed in the transcribed text. The text-generation machine-learning model may rank the set of entities based on the corresponding scores and output the text prompt with the entity associated with a highest score. In some embodiments, the scoring is performed by an intermediate layer in a neural network.

In some embodiments, the text-generation module 204 may include a plurality of trained text-generation machine-learning models. One or more of the text-generation machine-learning models may include a plurality of nodes, arranged into layers per the model structure or form. In some embodiments, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processor cores of a multicore processor, using individual processing units of a graphics processing unit (GPU), or special-purpose neural circuitry. In some embodiments, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The text-generation machine-learning model may then be trained, e.g., using training data, to produce a result.

Training may be performed by using supervised learning techniques. In supervised learning, the training data can include a plurality of inputs (e.g., a plurality of transcribed text documents) and a corresponding ground truth output for each input (e.g., text prompts for each transcribed text document). Based on a comparison of the output of the model (e.g., predicted text prompts) with the ground truth output (e.g., the ground truth summaries), values of the weights are automatically adjusted, e.g., in a manner that increases a probability that the model produces the ground truth channels.

In some embodiments, the training is unsupervised. The text may be divided into clusters and the clusters may be organized according to the similarity of the text.

In various embodiments, a trained model includes a set of weights, or embeddings, corresponding to the model structure. In some embodiments, the trained text-generation machine-learning model may include an initial set of weights, e.g., downloaded from a server that provides the weights. In various embodiments, a trained text-generation machine-learning model includes a set of weights, or embeddings, corresponding to the model structure. In embodiments where data is omitted, the text-generation module 204 may generate a trained text-generation machine-learning model that is based on prior training, e.g., by a developer of the text-generation module 204, by a third-party, etc.

In some embodiments, where the text-generation machine-learning model includes a convolutional neural network trained using supervised learning, the training of the text-generation machine-learning model may include, for each training transcribed text, obtaining text prompts based on the transcribed text. The text-generation machine-learning model may calculate a loss value based on a comparison of the predicted text prompts and ground truth text prompts (included in the training data) for the transcribed text. The text-generation machine-learning model may update a weight of one or more nodes of the convolutional neural network based on the loss value (e.g., in a way that, after adjustment and running another cycle of the training, the loss value is reduced, till the loss value is below a threshold). In some embodiments, the text-generation machine-learning model includes learnable convolutional encoder and decoder layers with a time-domain convolutional network masking network.

Once the text-generation machine-learning model is trained, the text-generation machine-learning model receives a transcribed text (from a video communication session) as input and outputs a text prompt. The text-generation module 204 provides the text prompt as input to an image-generation module 206.

In some embodiments, the text-generation machine-learning model receives the additional transcribed text from the video module 202 and generates a further text prompt based on the additional transcribed text.

The image-generation module 206 may include an image-generation machine-learning model that receives the text prompt as input and outputs a generated image. The generated image is responsive to the text prompt and includes a depiction of the entity in the transcribed text.

In some embodiments, the image-generation module 206 trains the image-generation machine-learning model using training data that includes text prompts as input and generates images as ground truth data.

The image-generation machine-learning model may be an autoregressive text-to-image generation model that generates images that support context-rich synthesis involving complex compositions and world knowledge. In some embodiments, the image-generation machine-learning model encodes images as sequences of discrete tokens.

Alternatively, the image-generation machine-learning model may use a diffusion model to output the generated image. A diffusion model may perform text conditioning of the text prompt. For example, if the text request is for replacing a shirt that a subject is wearing in the initial image with a blue shirt, the diffusion model performs text conditioning by generating a blue shirt.

The diffusion model may perform a diffusion process on a noisy image. Diffusion models are trained by adding noise to images and training the diffusion model to remove the noise via a denoising process. During actual use, a diffusion model applies the denoising process to random seeds to generate realistic images. By simulating diffusion, the diffusion model generates noisy images and then performs reverse diffusion, which is the process of an output image emerging from noise.

In some embodiments, the diffusion model first performs an inverse diffusion to create a noisy image, provides the noisy image to a convolutional neural network with a self-attention mechanism for performing feature extraction, and then performs a forward diffusion that combines the noisy image with the text conditioning to generate an output image that satisfies a text prompt provided as input to the diffusion model. In some embodiments, the diffusion model performs the inverse diffusion using a denoising diffusion implicit model (DDIM) inversion.

The trained image-generation machine-learning model receives a text prompt from the text-generation machine-learning model. The image-generation machine-learning model outputs a generated image that is responsive to the text prompt and that includes a depiction of the entity in the transcribed text.

In some embodiments, the image-generation machine-learning model receives a further text prompt and updates, with the image-generation machine-learning model, the generated image responsive to the further text prompt. The image-generation machine-learning model may update the generated image progressively over time while retaining a depiction of each entity in the initial generated image. For example, a first summary may include “There is a planet called earth” and the generated image is of earth. A second summary may include “On it, lived dinosaurs” and the updated generated image includes earth with a dinosaur on the surface. A third summary may include “Earth was struck by meteorites” and the updated generated image includes earth with a dinosaur being hit by a meteorite. A fourth summary may include “Dinosaurs went extinct and earth became a ball of fire” where the updated generated image includes a ball of fire.

Once the video communication session has ended, the text-generation machine-learning model may generate a summary of the transcribed text. The summary may include an amalgamation of previous summaries that were generated iteratively during a live video communication session, or the summary may be generated based on a complete transcribed text that represents the entire video communication session. In some embodiments, an indexer 208 may index the summary of the transcribed text using the generated image. For example, the summary of the transcribed text may be indexed with a thumbnail version of the generated image.

In some embodiments, where the generated image is updated over time, the image-generation module 206 may generate a video clip of the generated image and updates to the generated image that the indexer 208 indexes as a thumbnail version of the video clip associated with the summary. The thumbnail version of the generated image or the video clip advantageously allows a user to quickly identify a particular video communication session based on looking at the thumbnail version.

The indexer 208 saves the summary and corresponding thumbnail version of the generated image with specific user permission. In some embodiments, the summary is discarded after completion of a video communication session unless a user provides permission to save the summary. In some embodiments, the indexer 208 provides the user with an option to save the generated image(s) in association with the transcribed text of the video communication session and indexes the generated image responsive to receiving a selection of the option from the user. In some embodiments, if the user does not provide permission to save the summary, the indexer 208 deletes the transcribed text and/or the summary after the video communication session ends. In some embodiments, if the user does not provide permission to save the generated images, the image-generation module 206 may generate any generated images.

In addition or alternatively to using the generated image in indexing the summary described above, it may also be used to index other content related to the video communication session that may be stored, such as an audio and/or visual recording of the video communication session. Indeed, generating images to index files in this way may not be restricted to video communication sessions, and may also apply to, for example, audio communication sessions without any visual element. However, it may be useful that the generated image has been displayed to the user during the communication session such that recognition for later retrieval of indexed content is facilitated.

### Example User Interfaces

In some embodiments, the transcribed text describes multiple entities. For example, a first user may describe that on their last vacation, they were in a hot-air balloon for the first time. The second user may describe that on their last vacation, they went back-country skiing in the mountains. In this example, the transcribed text includes the following entities: a hot-air balloon and mountains where a person would go back-country skiing.

The text-generation module 204 receives the transcribed text and outputs a text prompt that requests a generated image that includes a hot-air and mountains where a person would go back-country skiing. The image-generation module 206 receives the text prompt and outputs a generated image based on the text prompt that includes the entities in the text prompt. In some embodiments, the generated image depicts a logical connection between a first entity and a second entity. For example, instead of a generated image that includes a hot-air balloon that is the same size as the mountains, the generated image includes a hot-air balloon that is sized and positioned so that the hot-air balloon is part of the same scene as the mountains.

In some embodiments, the generated image is displayed in the video communication session. For example, a generated image is displayed while a user hears audio associated with the video communication session.

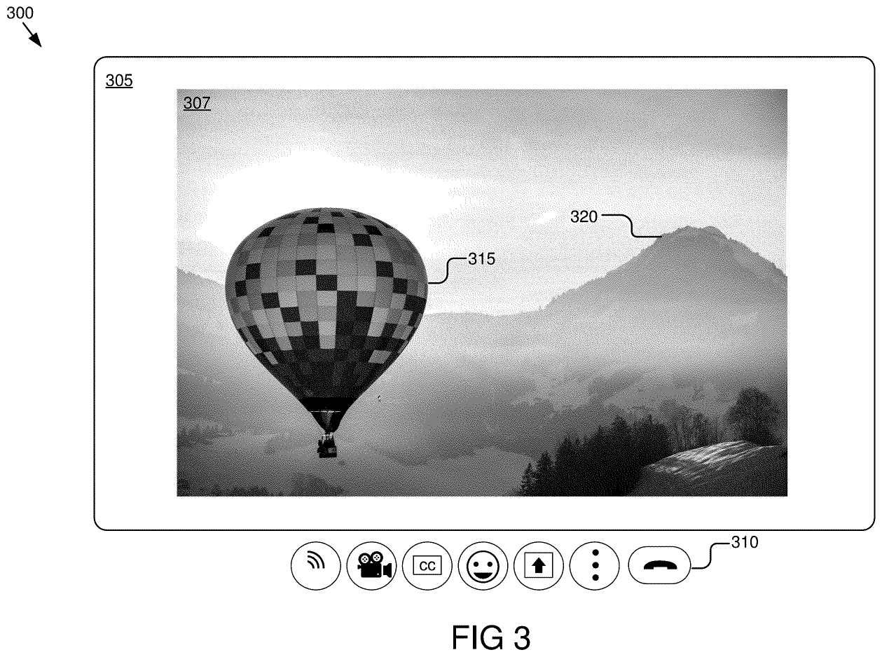

FIG. 3 illustrates an example user interface 300 that includes a generated image 307. The user interface 300 includes a video screen 305 with the generated image and video communication session icons, such as the phone icon that, when selected, ends the video communication session. The generated image 307 includes the hot-air balloon 315 and the mountains 320 where a person would go back-country skiing. As a result, the generated image advantageously combines visual aspects that relate to entities from each person participating in the video communication session.

As the video communication session continues, the video module 202 obtains additional transcribed text from audio associated with the video communication session. The text-generation machine-learning model receives the additional transcribed text as input and outputs a further text prompt. The image-generation machine-learning model receives the additional text prompt and updates the generated image to be responsive to the further text prompt. For example, continuing with the details above, the first user may additionally describe how after the hot-air balloon trip, they went on a wine-tasting tour.

The image-generation machine-learning model may update the generated image to include entities associated with wine-tasting, such as rolling hills in Nappa valley that include vineyards where they conduct wine tasting events. The image-generation module 206 may update the generated image to show one or more of the entities transitioning into the additional entities. For example, the mountains may transition into the rolling hills in Nappa valley.

In some embodiments, the generated image is displayed as a background image behind a video of one or more participants in the video communication session. The image-generation module 206 may output a generated image with a negative space for a user's image to be placed. In some embodiments, the image-generation module 206 adjusts the brightness, contrast, and coloration of the video stream of the users so that it appears that the users are in the environment.

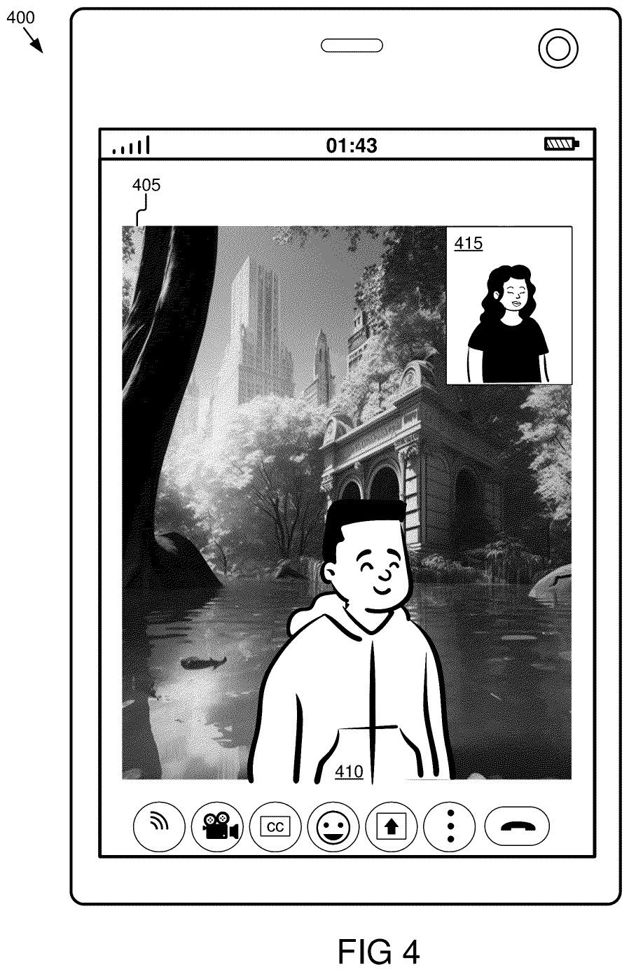

FIG. 4 illustrate an example user interface 400 that includes a background generated image. In this example, a first user 410 describes that during the last weekend, he attended an animated movie that primarily takes place under water. The second user 415 describes how she spend a day of her weekend walking around Central Park. The image-generation machine-learning model outputs a generated image 405 that depicts a part of Central Park and adds an underwater element to the generated image.

In some embodiments, the generated image is displayed separate from the videos of each user. For example, the video conference session may include a first image of a first user, a second image of a second user, and a third image that is the generated image.

In some embodiments, instead of a text prompt, the image-generation machine-learning model receives prewritten text as input and outputs one or more images based on entities detected in the prewritten text. The one or more images may be used as a set of suggested backgrounds for use during a video communication session. For example, a parent may want to use the video communication session to read a story to the parent's son and the set of backgrounds may include typical characters in stories, such as a princess, a prince, a castle, a monster, a knight, etc. Because the image-generation machine-learning model may update a generated image based on additional transcribed text, the suggested backgrounds serve as a useful starting point for a story where the entities transition into other entities as the parent reads the story.

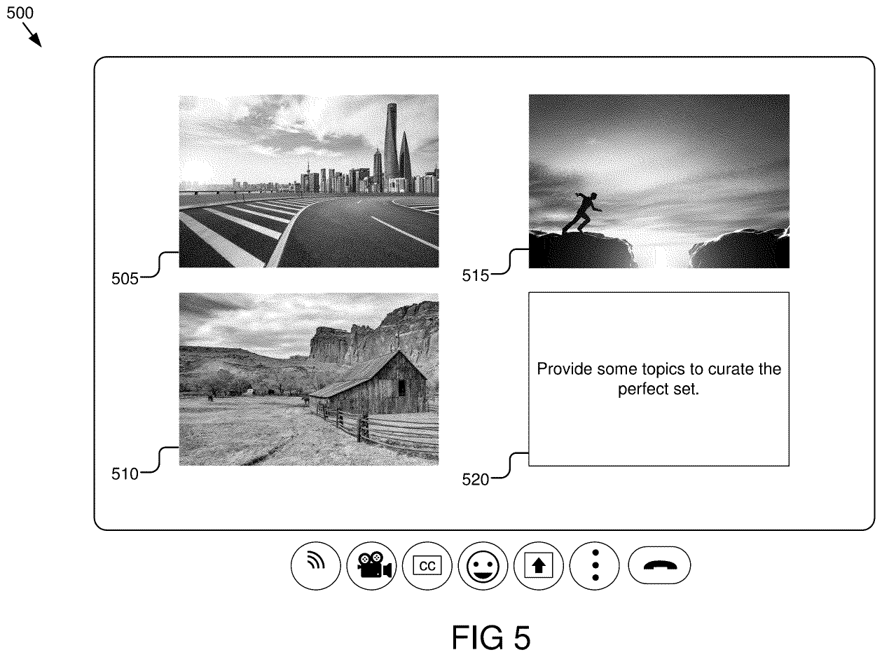

FIG. 5 illustrates an example user interface 500 with suggested backgrounds that are pre-generated for use during a video communication session. In this example, the image-generation machine-learning model outputs three images based on pre-written text 505, 510, 515.

In some embodiments, the image-generation machine-learning model may output images based on user input. For example, a user may select the box 520 in FIG. 5 to provide entities that the image-generation machine-learning model directly uses to output a generated image or that the text-generation machine-learning model receives as input and uses to generate a text prompt that is used by the image-generation machine-learning model to output the generated image.

In some embodiments, prior to a video communication session, the text-generation machine-learning model receives prewritten text and outputs a text prompt for the prewritten text. The image-generation machine-learning model may receive the text prompt for the prewritten text and output one or more images based on entities detected in the text prompt. Alternatively, the image-generation machine-learning model may directly receive the prewritten text and output the one or more images based on the entities detected in the prewritten text.

During a video communication session, the text-generation machine-learning model may detect that the transcribed text matches a particular portion of the prewritten text and the image-generation machine-learning model may cause a corresponding pre-generated image to be displayed.

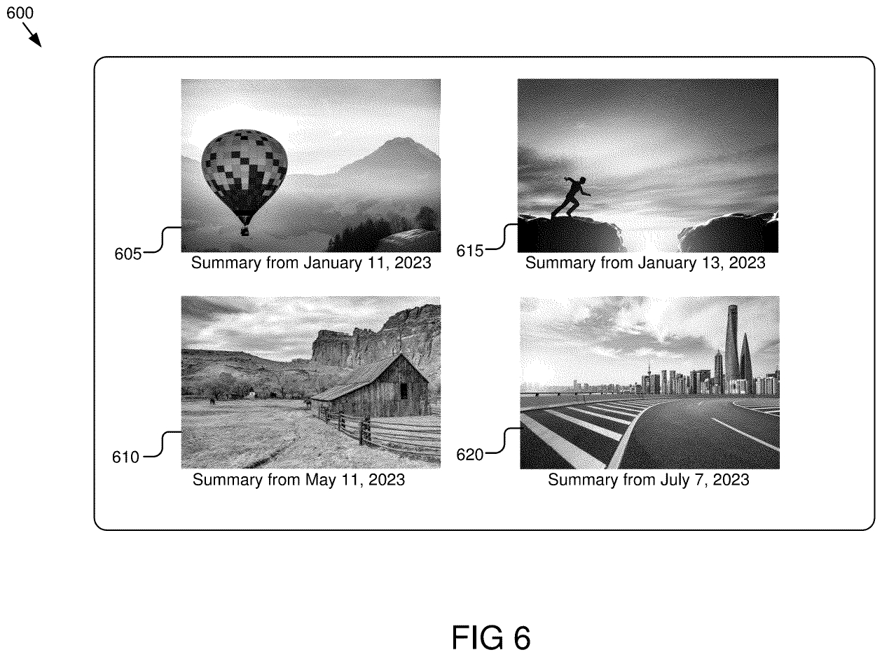

FIG. 6 illustrates an example user interface 600 with thumbnail versions of generated images 605, 610, 615, 620 that are indexed according to the video communication sessions. In some embodiments, selecting one of the thumbnails causes a corresponding summary to be displayed.

### Example Flowcharts

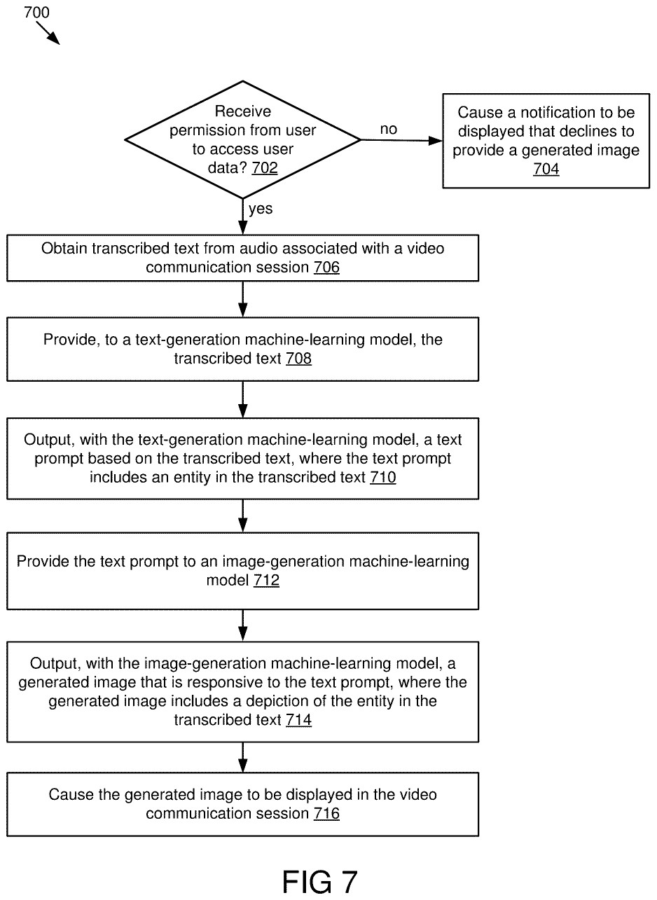

FIG. 7 illustrates an example flowchart of a method 700 to output a generated image for a video communication session. The method 700 may be performed by the computing device 200 in FIG. 2. In some embodiments, the method 700 is performed by the user device 115, the media server 101, or in part on the user device 115 and in part on the media server 101 of FIG. 1,

The method 700 of FIG. 7 may begin at block 702. At block 702, it is determined whether permission was received from a user to access user data. If permission was not received, block 702 may be followed by block 704. At block 704, a notification is caused to be displayed that declines to provide a generated image. If permission is received, 702 may be followed by block 706.

At block 706, transcribed text is obtained from audio associated with a video communication session. Block 706 may be followed by block 708.

At block 708, a text-generation machine-learning model is provided with the transcribed text. Block 708 may be followed by block 710.

At block 710, the text-generation machine-learning model outputs a text prompt based on the transcribed text, where the text prompt includes an entity in the transcribed text, In some embodiments, the text-generation machine-learning model identifies the entity from the transcribed text by generating a summary of the transcribed text and comparing the summary to a plurality of entities to identify the entity based on corresponding distances between the summary and the plurality of clusters of entities. In some embodiments, the transcribed text includes multiple entities and the method further includes scoring a set of entities based on a visual aspect associated with each entity in the set of entities, where outputting the text prompt comprises outputting the text prompt with the entity associated with a highest score. In some embodiments, the entity is a plurality of entities, a first entity is based on audio from a first user associated with the video communication session, a second entity is based on audio from a second user associated with the video communication session, and the generated image depicts a logical connection between the first entity and the second entity. Block 710 may be followed by block 712.

At block 712, the text prompt is provided to an image-generation machine-learning model. Block 712 may be followed by block 714.

At block 714, the image-generation machine-learning model outputs a generated image that is responsive to the text prompt, where the generated image includes a depiction of the entity in the transcribed text. Block 714 may be followed by block 716.

At block 716, the generated image is caused to be displayed in the video communication session. In some embodiments, the generated image is displayed as a background image behind a video of one or more participants in the video communication session. In some embodiments, the method further includes providing an option to save the generated image in association with the transcribed text of the video communication session (or other content related to the video communication session, such as an audio and/or video recording). In some embodiments, a summary of the transcribed text and/or other content relating to the video communication session is indexed with a thumbnail version of the generated image. In some embodiments, the transcribed text is deleted after the video communication session ends.

In some embodiments, the method further includes obtaining additional transcribed text from audio associated with the video communication session. The text-generation machine-learning model outputs a further text prompt based on the additional transcribed text, where the further text prompt includes an additional entity in the additional transcribed text. Responsive to the further text prompt, the further text prompt is provided to the image-generation machine-learning model, and the updated generated image includes a depiction of the additional entity in the additional transcribed text.

In some embodiments, the video communication session is a live session, and the method is performed a plurality of times during the live session with incremental audio received during a period between consecutive execution of the method. Furthermore, instead of one entity, a plurality of entities is identified and one or more of the plurality of entities transition into one or more of the plurality of entities based on the incremental audio.

In some embodiments, before the video communication session, the method further includes receiving prewritten text, the image-generation machine-learning model outputting one or more entities based on entities detected in the prewritten text, detecting that the transcribed text matches a particular portion of the prewritten text, and causing a corresponding pre-generated image to be displayed. The method may further include generating graphical data for displaying a user interface that includes a set of suggested backgrounds for use during the video communication session.

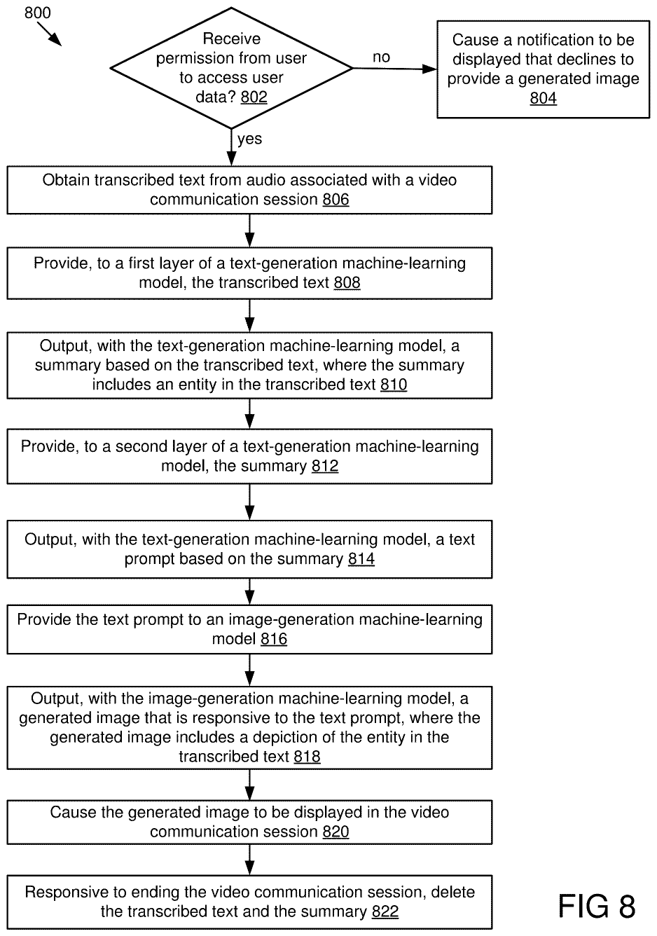

FIG. 8 illustrates another example flowchart of a method 800 to output a generated image for a video communication session. The method 800 may be performed by the computing device 200 in FIG. 2. In some embodiments, the method 800 is performed by the user device 115, the media server 101, or in part on the user device 115 and in part on the media server 101 of FIG. 1.

The method 800 of FIG. 8 may begin at block 802. At block 802, it is determined whether permission was received from a user to access user data. If permission was not received, block 802 may be followed by block 804. At block 804, a notification is caused to be displayed that declines to provide a generated image. If permission is received, 802 may be followed by block 806.

At block 806, transcribed text from audio associated with a video communication session is obtained. Block 806 may be followed by block 808.

At block 808, the transcribed text is provided to a first layer of a text-generation machine-learning model. Block 808 may be followed by block 810.

At block 810, the text-generation machine-learning model outputs a summary based on the transcribed text, where the summary includes an entity in the transcribed text. Block 810 may be followed by block 812.

At block 812, the summary is provided to a second layer of a text-generation machine-learning model. Block 812 may be followed by block 814.

At block 814, the text-generation machine-learning model outputs a text prompt based on the summary. Block 814 may be followed by block 816.

At block 816, the text prompt is provided to an image-generation machine-learning model. Block 816 may be followed by block 818.

At block 818, the image-generation machine-learning model outputs a generated image that is responsive to the text prompt, where the generated image includes a depiction of the entity in the transcribed text. Block 818 may be followed by block 820.

At block 820, the generated image is caused to be displayed in the video communication session. Block 820 may be followed by block 822,

At block 822, responsive to ending the video communication session, the transcribed text and the summary are deleted.

Further to the descriptions above, a user may be provided with controls allowing the user to make an election as to both if and when systems, programs, or features described herein may enable collection of user information (e.g., use of video communication session data, generation of transcribed text, generation of a summary, generation of generated images, use of generative artificial intelligence, storage of data, etc., information about a user's activities, profession, a user's preferences, or a user's current location), and if the user is sent content or communications from a server. For video communication sessions, all participants of the video communication sessions provide permission for the use of the data mentioned previously. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user,

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory, These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMS, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
obtaining transcribed text from audio associated with a video communication session;
providing, to a text-generation machine-learning model, the transcribed text;
outputting, with the text-generation machine-learning model, a text prompt based on the transcribed text, wherein the text prompt includes an entity in the transcribed text;
providing the text prompt to an image-generation machine-learning model;
outputting, with the image-generation machine-learning model, a generated image that is responsive to the text prompt, wherein the generated image includes a depiction of the entity in the transcribed text; and
causing the generated image to be displayed in the video communication session.

2. The method of claim 1, further comprising identifying the entity from the transcribed text by:
generating a summary of the transcribed text; and
comparing the summary to a plurality of clusters of entities to identify the entity based on corresponding distances between the summary and the plurality of clusters of entities, wherein the summary is provided to the text-generation machine-learning model.

3. The method of claim 1, wherein the generated image is displayed as a background image behind a video of one or more participants in the video communication session.

4. The method of claim 1, further comprising obtaining additional transcribed text from audio associated with the video communication session;
outputting, with the text-generation machine-learning model, a further text prompt based on the additional transcribed text, wherein the further text prompt includes an additional entity in the additional transcribed text;
providing the further text prompt to the image-generation machine-learning model; and
updating, with the image-generation machine-learning model, the generated image to be responsive to the further text prompt, wherein the updated generated image includes a depiction of the additional entity in the additional transcribed text.

5. The method of claim 1, wherein the video communication session is a live session, and the method is performed a plurality of times during the live session with incremental audio received during a period between consecutive execution of the method.

6. The method of claim 5, wherein the entity includes a plurality of entities and the plurality of entities transition into other entities based on the incremental audio.

7. The method of claim 1, further comprising:
generating a summary of the transcribed text; and
indexing the summary of the transcribed text with a thumbnail version of the generated image.

8. The method of claim 1, further comprising:
scoring, with the text-generation machine-learning model, a set of entities based on a visual aspect associated with each entity in the set of entities;
wherein outputting the text prompt comprises outputting the text prompt with the entity associated with a highest score.

9. The method of claim 1, wherein the entity is a plurality of entities, a first entity is based on audio from a first user associated with the video communication session, a second entity is based on audio from a second user associated with the video communication session, and the generated image depicts a logical connection between the first entity and the second entity.

10. The method of claim 1, further comprising:
prior to the video communication session, receiving prewritten text;
outputting, with the image-generation machine-learning model, one or more images based on entities detected in the prewritten text;
detecting that the transcribed text matches a particular portion of the prewritten text; and
causing a corresponding pre-generated image to be displayed in the video communication session.

11. The method of claim 10, further comprising:
generating graphical data for displaying a user interface that includes a set of suggested backgrounds for use during the video communication session, wherein the set of suggested backgrounds include the one or more images.

12. The method of claim 1, further comprising:
providing an option to save the generated image in association with the transcribed text of the video communication session.

13. The method of claim 1, further comprising:
deleting the transcribed text after the video communication session ends.

14. A non-transitory computer-readable medium with instructions stored thereon that, when executed by one or more processors, cause the one or more processors to perform operations, the operations comprising:
obtaining transcribed text from audio associated with a video communication session;
providing, to a text-generation machine-learning model, the transcribed text;
outputting, with the text-generation machine-learning model, a text prompt based on the transcribed text, wherein the text prompt includes an entity in the transcribed text;
providing the text prompt to an image-generation machine-learning model;
generating, with the image-generation machine-learning model, a generated image that is responsive to the text prompt, wherein the generated image includes a depiction of the entity in the transcribed text; and
causing the generated image to be displayed in the video communication session.

15. The non-transitory computer-readable medium of claim 14, wherein the operations further include identifying the entity from the transcribed text by:
generating a summary of the transcribed text; and
comparing the summary to a plurality of clusters of entities to identify the entity based on corresponding distances between the summary and the plurality of clusters of entities wherein the summary is provided to the text-generation machine-learning model.

16. The non-transitory computer-readable medium of claim 14, wherein the generated image is displayed as a background image behind a video of one or more participants in the video communication session.

17. The non-transitory computer-readable medium of claim 14, wherein the operations further include:
obtaining additional transcribed text from audio associated with the video communication session
outputting, with the text-generation machine-learning model, a further text prompt based on the additional transcribed text, wherein the further text prompt includes an additional entity in the additional transcribed text;
providing the further text prompt to the image-generation machine-learning model; and
updating, with the image-generation machine-learning model, the generated image to be responsive to the further text prompt, wherein the updated generated image includes a depiction of the additional entity in the additional transcribed text.

18. A computing device comprising:
a processor; and
a memory coupled to the processor, with instructions stored thereon that, when executed by the processor, cause the processor to perform operations comprising:
obtaining transcribed text from audio associated with a video communication session;
providing, to a text-generation machine-learning model, the transcribed text;
outputting, with the text-generation machine-learning model, a text prompt based on the transcribed text, wherein the text prompt includes an entity in the transcribed text;
providing the text prompt to an image-generation machine-learning model;
generating, with the image-generation machine-learning model, a generated image that is responsive to the text prompt, wherein the generated image includes a depiction of the entity in the transcribed text; and
causing the generated image to be displayed in the video communication session.

19. The computing device of claim 18, wherein the operations further include identifying the entity from the transcribed text by:
generating a summary of the transcribed text; and
comparing the summary to a plurality of clusters of entities to identify the entity based on corresponding distances between the summary and the plurality of clusters of entities wherein the summary is provided to the text-generation machine-learning model.

20. The computing device of claim 18, wherein the generated image is displayed as a background image behind a video of one or more participants in the video communication session.
